(19) United States
(12) Patent Application Publication
(10) Pub. No.: US 2016/0360546 A1
(43) Pub. Date: Dec. 8, 2016

(54) CONTENTION FOR SHARED WIRELESS COMMUNICATION CHANNEL USING MULTIPLE DEDICATED SENSING INTERVALS

(71) Applicant: Texas Instruments Incorporated, Dallas, TX (US)

(72) Inventors: Arvind Kandhalu Raghu, Plano, TX (US); Ariton E. Xhafa, Plano, TX (US); Ramanuja Vedantham, Allen, TX (US)

(21) Appl. No.: 14/982,418

(22) Filed: Dec. 29, 2015

Related U.S. Application Data
(60) Provisional application No. 62/169,988, filed on Jun. 2, 2015.

(51) Int. Cl. H04W 72/12; H04W 72/04; H04W 74/08

(52) U.S. Cl. CPC H04W 72/1242; H04W 74/08; H04W 74/0816; H04W 72/0446

(57) ABSTRACT

Transmission on a shared wireless communication channel is contended for by selecting one of a predetermined plurality of dedicated channel sensing intervals, and then performing channel sensing relative to the channel during the selected channel sensing interval. A transmission is sent on the channel in response to a determination that the channel is idle.

This application claims 35 USC 119 priority to copending U.S. Provisional Application No. 62/169,988, filed on Jun. 2, 2015 and incorporated herein by reference.

### FIELD

The present work relates to shared channel wireless communications and, more particularly, to contention for transmit access to a shared wireless communication channel.

### BACKGROUND

FIG. 1 diagrammatically illustrates a conventional arrangement of wireless communication devices 12 to implement short-range ad hoc wireless networks. The devices 12 are typically battery-powered devices. An ad hoc network is formed by peer-to-peer wireless communication links 14 among a group of the devices 12. As one example, the network nay be a conventional IEEE 802.15.4e network, with each of the devices 12 provided as a conventional IEEE 802.15.4e communication node. One or more leaf nodes are linked to a root node either by a direct peer-to-peer link, or via one or more intermediate nodes and a corresponding chain of peer-to-peer links. The corresponding IEEE 802.15.4e Standard (2012) is incorporated herein by reference.

IEEE 802.15.4e is an amendment to the IEEE 802.15.4 Standard (2006), which latter standard is incorporated herein by reference. The IEEE 802.15.4e amendment specifically targets media access control (MAC) protocol level modifications to enhance the performance of 802.15.4 devices. A specific 15.4e MAC operation is referred to as Time Shared Channel Hopping (TSCH). TSCH enables robust as well as low-power communication. Channel hopping provides robustness against interference. The time-slotted and time-synchronized nature of the protocol allows for time-scheduled communication, where the devices need to be active only when required, and can otherwise remain in a sleep mode. This provides for low-power operation.

TSCH uses time frames, with each frame containing some number of time slots. Among those time slots, there is at least one beacon slot and a shared slot. A beacon slot is used by a dedicated root node or intermediate node to transmit a beacon packet that provides the transmit/receive schedule of the other nodes in the network. The beacon slot is also used for time synchronization purposes. The shared slot is a contention slot for use by new nodes attempting to join the network (and for any other network maintenance related packets). The association of devices when joining the network occurs through shared slots. Also, aperiodic low-latency traffic uses shared slots, as do network management related packets. Besides the beacon slot(s) and the shared slot, the frame may also include a receive slot and transmit slot.

FIG. 2 is a timing diagram (not to scale) of a pertinent portion of the aforementioned shared slot. As indicated above, TSCH is a tightly time synchronized protocol. In the shared slot portion shown in FIG. 2, a node desirous of transmitting on a shared channel performs known clear channel assessment (CCA) operations during a CCA interval. If the channel is determined to be idle, then the node will transmit (after a transmit/receive turn-around time designated as TsRxTx) during a transmit interval Tx. If the channel is busy, the node does not transmit, and awaits the next shared slot.

The present work has recognized that the time synchronization of TSCH means that nodes contending for the shared channel will commence the CCA operation at almost the same instant of time. Even if there is a clock drift, unless that drift is at least greater than 300 us (CCA duration+TsRxTx duration), all the nodes contending for the channel will sense the channel as idle, and accordingly transmit during the Tx interval. This will cause collisions that result in increased network latency and increased power consumption among the nodes. The present work has also recognized that there is no way to prioritize the contending traffic such that higher priority traffic will win contention more than lower priority traffic.

### BRIEF DESCRIPTION OF THE DRAWINGS

In the drawings referenced herein:

FIG. 1 diagrammatically illustrates a conventional arrangement of wireless communication devices that implements short-range ad hoc networks;

FIG. 2 is a timing diagram of a conventional approach to shared channel contention;

FIG. 3 is a timing diagram of a shared channel contention scheme according to example embodiments of the present work;

FIG. 4 illustrates a portion of FIG. 3 in more detail according to example embodiments of the present work;

FIG. 5 illustrates shared channel contention operations performed according to example embodiments of the present work;

FIG. 6 illustrates operations of a traffic prioritization scheme according to example embodiments of the present work; and

FIG. 7 diagrammatically illustrates a wireless communication apparatus according to example embodiments of the present work.

### DETAILED DESCRIPTION

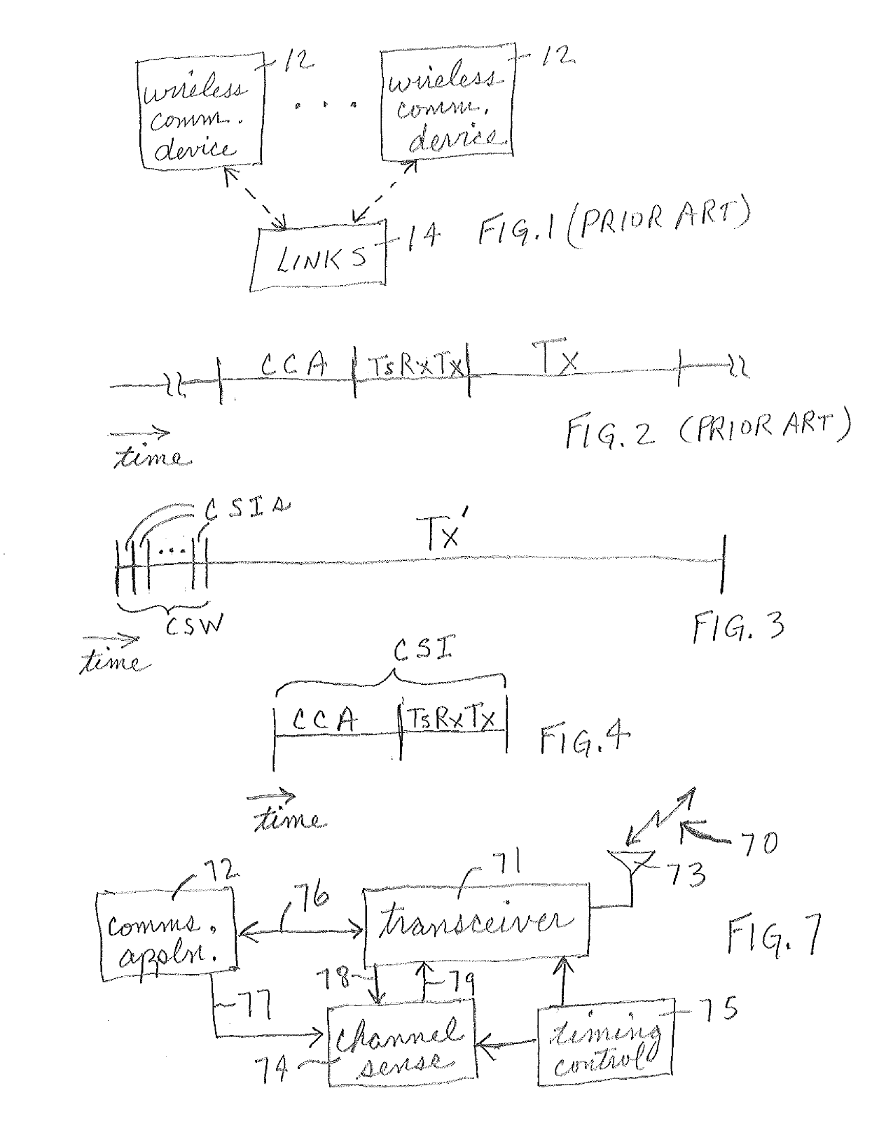

FIG. 3 is a timing diagram (not to scale) of a shared channel contention scheme according to example embodiments of the present work. In some embodiments, the time period illustrated in FIG. 3 is equal in duration to the Tx interval shown in FIG. 2, and the operations described herein relative to FIG. 3 replace the transmit operation performed during the Tx interval of FIG. 2. As shown in FIG. 3, a channel sensing window CSW is established at the beginning of the illustrated time period, and is divided into a plurality of predetermined channel sensing intervals which are designated by CSI and have equal duration. In some embodiments, the CSIs are temporally consecutive and temporally adjacent within the CSW, as shown in FIG. 3. A transmit interval Tx′ follows the CSW.

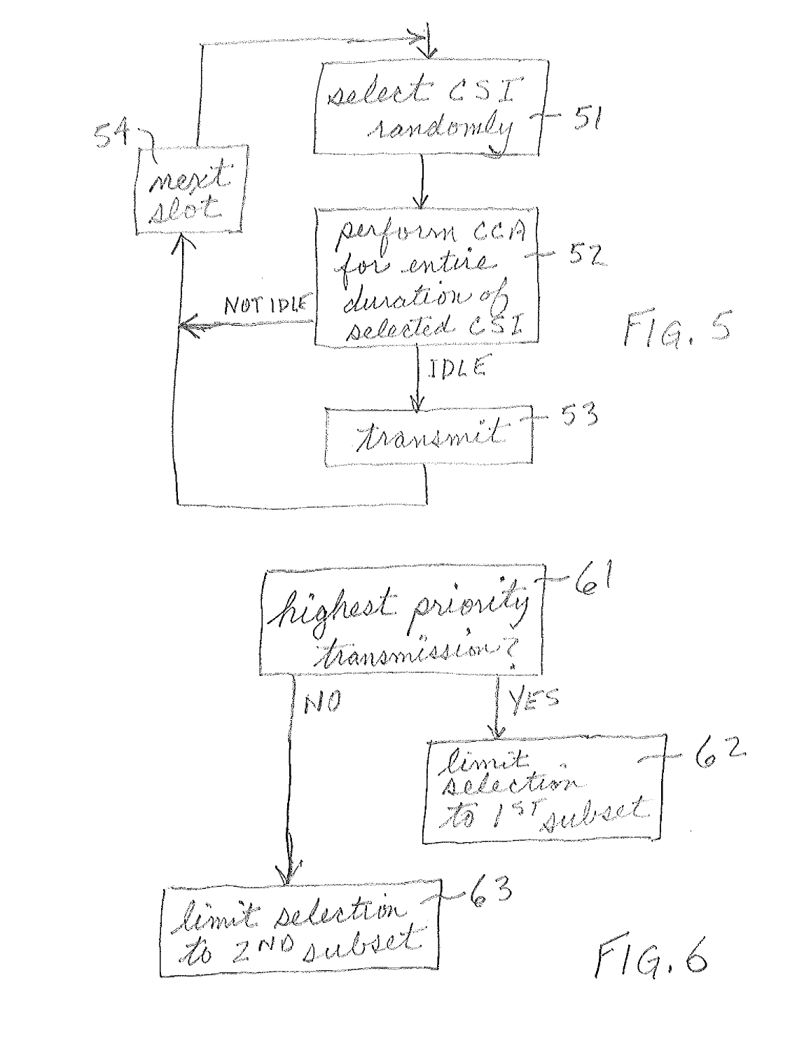

FIG. 4 illustrates a CSI of FIG. 3 in more detail (not to scale) according to example embodiments of the present work. As shown, the CSI in this example has a duration equal to the sum of the CCA and TsRxTx durations of FIG. 2.

FIG. 5 illustrates operations performed according to example embodiments of the present work. At 51, a CSI is selected randomly from the CSW (see also FIG. 3). At 52, conventional CCA is performed for the entire duration of the selected CSI. If CCA determines at 52 that the channel is idle, then a transmission is sent at 53, after which the next shared slot is awaited at 54. If CCA determines at 52 that the channel is not idle, then the next shared slot is awaited at 54. Referring also to FIGS. 2 and 3, the maximum duration of the transmission at 53 is, in some embodiments, equal to the duration of the Tx′ interval, which is less than the duration of the Tx interval in FIG. 2. This maximum limit corresponds to the transmission time available if the last CSI is selected. Note also that the transmission at 53 commences immediately upon expiration of the selected CSI, i.e., at commencement of the next CSI (or at commencement of the Tx′ interval if the last CSI was selected).

FIG. 6 illustrates operations of a traffic prioritization scheme that may be used in conjunction with the operations described above relative to FIGS. 3-5 according to example embodiments of the present work. If a desired transmission has a highest priority at 61, then at 62 the random selection of CSI (see also 51 in FIG. 5) is limited to only a first subset of the CSIs. In some embodiments, the random selection at 62 is limited to those CSIs in the earliest half of the CSW. If the desired transmission does not have the highest priority at 61, then at 63 the random selection of CSI is limited to only a second subset of the CSIs, where the second subset is disjoint from the first subset. In some embodiments, the random selection at 63 is limited to those CSIs in the latter half of CSW. It can be seen that the operations at 61-63 ensure that traffic of a given priority class contends only with other traffic of the same priority class.

Various embodiments extend the prioritization scheme to various numbers of priority classes. As an example, the CSW can be divided into three subsets of the total set of CSIs, where the subsets are mutually disjoint, and temporally consecutive. High, middle and low priority traffic would then select only from CSIs located in the earliest, middle and latest subsets, respectively. The number of subsets, the size of each subset, and the assignment of priority classes to subsets are design parameters that may be adjusted as appropriate to the circumstances.

FIG. 7 diagrammatically illustrates a wireless communication apparatus according to example embodiments of the present work. In some embodiments, the apparatus of FIG. 7 may be operable in an arrangement such as described relative to FIG. 1. In some embodiments, the apparatus is compliant with IEEE 802.15.4e. In various embodiments, the apparatus performs some or all of the operations described relative to FIGS. 3-6. As shown in FIG. 7, a transceiver 71 is coupled at 76 to a communications application 72 for receiving from the communications application information for transmission via an antenna arrangement 73 and wireless channel 70, and for providing received information to the communications application. As used herein, “transceiver” can refer to a transmitter and receiver integrated into a single entity, to a transmitter and a receiver that are provided as separate and distinct entities, or generally to any arrangement that provides both wireless transmitting and receiving functionalities.

A channel sensing apparatus 74 is coupled to the transceiver 71, and a timing controller 75 is coupled to the channel sensing apparatus 74 and the transceiver 71. In some embodiments, the timing controller 75 provides timing signals to permit implementation of the operations described relative to Figured 3-6. The channel sensing apparatus 74 receives a channel input 78 from the transceiver 71, and performs clear channel assessment relative to the channel input 78 during a CSI randomly selected by channel sensing apparatus 74. A transmit enable signal 79 is provided to the transceiver 71 by the channel sensing apparatus 74 in response to a determination that the channel is idle.

In some embodiments, the channel sensing apparatus 74 receives from the communications application 72 a priority indication 77 (shown by broken line) that indicates the priority class of a desired transmission. The channel sensing apparatus 74 may then randomly select a CSI in accordance with the priority limitations described relative to FIG. 6.

In various embodiments, the components at 71, 72, 75 and 79 are provided on one or more integrated circuits.

Examples of advantageous aspects of the present work include reduction of network latency and node power consumption due to improved contention operation, and increased potential for more important traffic to be successful in channel contention.

Although example embodiments are described above in detail, this does not limit the scope of the present work, which may be practiced in a variety of embodiments.

What is claimed is:

1. A method of contending for transmission of a shared wireless communication channel, comprising:
selecting one of a predetermined plurality of dedicated channel sensing intervals;
performing channel sensing relative to the channel during the selected channel sensing interval to determine whether the channel is idle; and
sending a transmission on the channel in response to a determination that the channel is idle.

2. The method of claim 1, wherein the channel sensing intervals are temporally consecutive and temporally adjacent.

3. The method of claim 1, wherein, if said transmission is a highest priority transmission, said one channel sensing interval is selected from among only a first subset of said channel sensing intervals.

4. The method of claim 3, wherein said first subset consists of channel sensing intervals that all occur earlier than the remainder of said channel sensing intervals.

5. The method of claim 3, wherein, if said transmission is not a highest priority transmission, said one channel sensing interval is selected from among only a second subset of said channel sensing intervals that is disjoint from said first subset.

6. The method of claim 1, wherein said transmission commences immediately after the selected channel sensing interval expires.

7. The method of claim 1, provided for use in a node compliant with IEEE 802.15.4e, wherein said channel sensing intervals are of a duration that is a sum of an IEEE 802.15.4e clear channel assessment interval and an IEEE 802.15.4e transmit/receive turnaround time.

8. The method of claim 1, wherein said one channel sensing interval is selected randomly.

9. A wireless communication apparatus having a shared channel contention feature, comprising:
a transceiver;
a channel sensing apparatus coupled to said transceiver; and
a timing controller coupled to said transceiver and said channel sensing apparatus;
wherein said channel sensing apparatus and said timing controller are cooperable for permitting the apparatus to select one of a predetermined plurality of dedicated channel sensing intervals; and
wherein said transceiver and said channel sensing apparatus and said timing controller are cooperable for permitting the apparatus to perform channel sensing relative to a shared wireless communication channel during the selected channel sensing interval to determine whether the channel is idle; and
send a transmission on the channel in response to a determination that the channel is idle.

10. The apparatus of claim 9, wherein the channel sensing intervals are temporally consecutive and temporally adjacent.

11. The apparatus of claim 9, wherein, if said transmission is a highest priority transmission, said one channel sensing interval is selected from among only a first subset of said channel sensing intervals.

12. The apparatus of claim 11, wherein said first subset consists of channel sensing intervals that all occur earlier than the remainder of said channel sensing intervals.

13. The apparatus of claim 11, wherein, if said transmission is not a highest priority transmission, said one channel sensing interval is selected from among only a second subset of said channel sensing intervals that is disjoint from said first subset.

14. The apparatus of claim 9, wherein said transmission commences immediately after the selected channel sensing interval expires.

15. The apparatus of claim 9, provided as a node compliant with IEEE 802.15.4e, wherein said channel sensing intervals are of a duration that is a sum of an IEEE 802.15.4e clear channel assessment interval and an IEEE 802.15.4e transmit/receive turnaround time.

16. The apparatus of claim 9, wherein said one channel sensing interval is selected randomly.

17. A wireless communication apparatus having a shared channel contention feature, comprising:
means for selecting one of a predetermined plurality of dedicated channel sensing intervals;
means for performing channel sensing relative to a shared wireless communication channel during the selected channel sensing interval to determine whether the channel is idle; and
means for sending a transmission on the channel in response to a determination that the channel is idle.

18. The apparatus of claim 17, wherein the channel sensing intervals are temporally consecutive and temporally adjacent.

19. The apparatus of claim 17, wherein said one channel sensing interval is selected randomly.

20. The apparatus of claim 17, wherein said transmission commences immediately after the selected channel sensing interval expires.

21. The apparatus of claim 9, wherein said transceiver, said timing controller and said channel sensing apparatus are provided on one or more integrated circuits.
